(19) United States
(12) Patent Application Publication
(10) Pub. No.: US 2008/0134092 A1
(43) Pub. Date: Jun. 5, 2008

(54) DYNAMIC CREATION OF LABELS

(76) Inventors: Sonia Jean Cushing, Rochester, MN (US); John Walter Marreel, Rochester, MN (US); Kay Marie Momsen, Rochester, MN (US); Ryan T. Paske, Rochester, MN (US)

Correspondence Address: DUKE W. YEE;YEE & ASSOCIATES, P.C., P.O. BOX 802333, DALLAS, TX, 75380, US

(21) Appl. No.: 11/565,296

(22) Filed: Nov. 30, 2006

(51) Int. Cl. G06F 3/048

(52) U.S. Cl. 715/835

(57) ABSTRACT

A computer implemented method, apparatus, and computer usable program code for dynamically creating labels are provided. Fulfillment of customer orders has labeling requirements for which labels must be created. One or more images are selected from a repository of label sub-images based on a customer order to construct a finished label for use with the customer order. Label configurations are identified from a second repository to determine the arrangement of the label sub-images on the label layout. The selected images are arranged according to the label configurations into a single layout of a finished label. The finished label is included with the customer order. Finished labels created in this manner are created according to specific customer orders. This manner of label production uses fewer common types of label stock and eliminates the waste of pre-printed labels when changes are made to a customer order for any reason.

### 1. FIELD OF THE INVENTION

The present invention relates generally to an improved data processing system, and in particular, to a computer implemented method, apparatus, and computer usable program code for providing information about a customer order. Still more particularly, the present invention relates to a computer implemented method, apparatus, and computer usable program code for dynamic creation of labels according to customer orders.

### 2. DESCRIPTION OF THE RELATED ART

Virtually all commercially sold products include some labeling to communicate useful information about the product. Labels have various uses, for example, to indicate branding of a product, date and location of manufacture, contents of the product, instructions for using and disposing of the product, characteristics of the product, and compliance with regulations or standards. Labels serve many other purposes relevant to not only the product but also the product packaging and other product related materials.

Labels are generally seen placed on the product, product packaging, and supplementary materials included with the product. Sometimes, labels communicating information about a product may be placed on items separate from the product. For example, a label containing information about a product may be placed on a sample of the product that is sent to a laboratory, or on a compliance document sent to a government agency.

Labels are used throughout manufacturing facilities engaged in manufacturing products. Labels communicate information about products to customers, government agencies, different parts of manufacturing facilities, shippers, and many other entities involved in the manufacture, distribution, and consumption of products.

Information contained on labels varies depending on the product with which the label is to be associated. For example, a customer made computer system may need a label that provides information about the part numbers used in that computer system. Part number information varies depending on the specification of the custom made computer system, as does the label on which such information is ultimately placed. As another example, even for identical products, the labeling may be different because the final destination of the products may be in different countries with different compliance regulations and therefore different labeling requirements. Depending on the shape and size of information to be placed on a label, the shape and size of the label can vary.

In a manufacturing facility involved in producing a variety of products, variability of labels is an important manufacturing consideration. As labeling requirements change for the products being manufactured, a manufacturing facility has to provide for adequate lead time for suitable labels to be produced. Further, if labeling requirements change at the last minute after a labeling requirement has been released for the labels to be produced, the labels must be scrapped and new labels produced. Last minute labeling changes can be triggered by engineering change in the parts used in the product, substitution of parts for other reasons, change in regulations, change in destination of the product, and many other technical and business reasons.

### BRIEF SUMMARY OF THE INVENTION

The illustrative embodiments provide a computer implemented method, apparatus, and computer usable program code for dynamically creating labels. One or more images are selected from a repository based on a customer order. Label configurations are identified from a second repository. The selected images are arranged according to the label configurations into a single layout of a finished label. The finished label is included with the customer order.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a flowchart of the labeling process that is standard in the manufacturing industry in which illustrative embodiments may be implemented;

FIG. 4 is a flowchart of a process for creating the attributes of a dynamic label in accordance with an illustrative embodiment;

FIG. 5 is a flowchart of a process for creating a label configuration and layout for printing in accordance with an illustrative embodiment;

FIG. 6 is a flowchart of a process for creating a dynamic label in accordance with an illustrative embodiment;

FIG. 7 is a table of items translated from a customer order to manufacturing nomenclature in accordance with an illustrative embodiment;

FIG. 8 is a sample label data table in accordance with an illustrative embodiment; and

FIG. 9 is a diagram of a finished label in accordance with an illustrative embodiment.

### DETAILED DESCRIPTION OF THE INVENTION

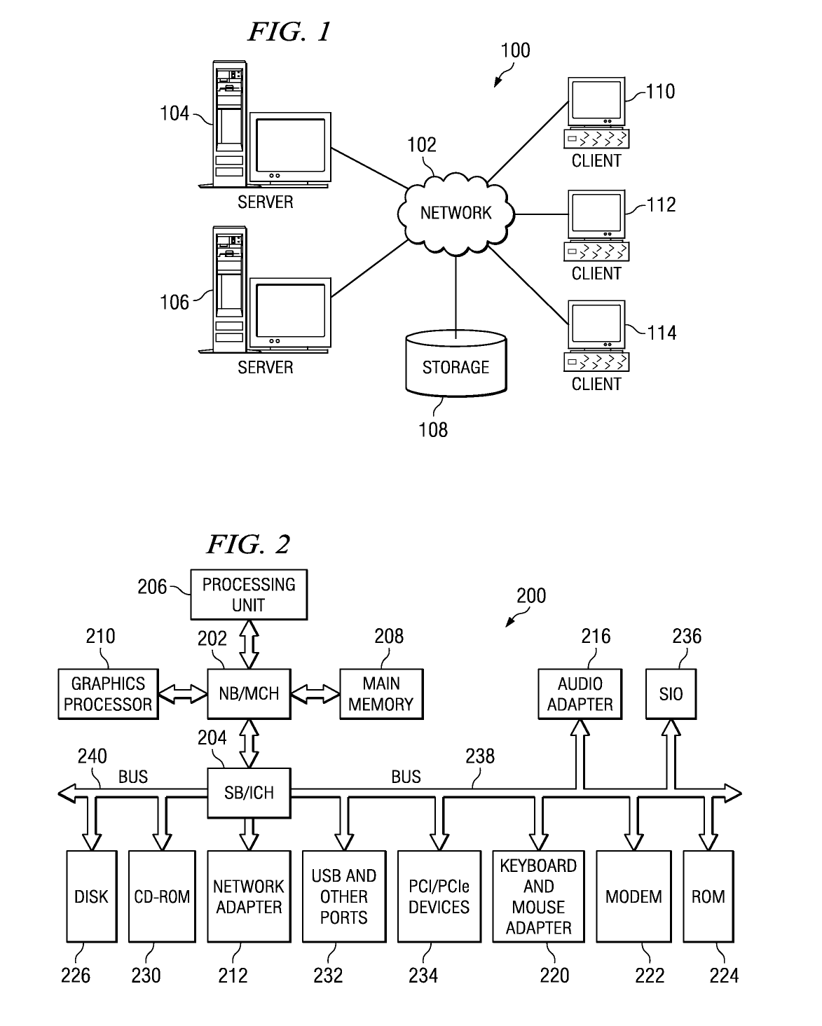

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 may also be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Labels are used throughout manufacturing facilities for communicating useful information to customers and government agencies among other entities interested in the product. Presently, the manufacturing industry procures the labels in one of two following ways: in a first way, a supplier supplies the labels that are manufactured according to the specifications of the manufacturing facility customer. In a second way that is especially used for small quantity needs for labels, a data processing system with software for creating and manipulating images is used to create the required labels. Such data processing systems are generally situated within the control of the manufacturing facility for meeting label requirements on short notice, and producing small batches of labels containing information provided on short notice.

Labels change depending on changes in the information to be contained on the labels. Sometimes the changes in the information to be placed on labels occur after the labels have been ordered from a supplier. Requirement that one or more labels be present for a product, and that the labels include or exclude certain information is called label requirement. Label requirements can come from the customer placing the customer order, a government agency empowered for regulation of the product, manufacturing procedures, and many other sources. A customer order is a requisition by a customer to purchase a product.

Illustrative embodiments recognize that as the label requirements change, production of new labels often requires significant lead time. Lead time is needed so that the suppliers of labels can manufacture the new labels and provide them to the manufacturing facility. Lead time is the amount of time a supplier needs in advance of the time when a customer needs to use the supplier's product, so that the supplier can plan, manufacture, and deliver the product to the customer.

Illustrative embodiments further recognize that when a supplier supplies the labels, changes in the label requirements affect cost of labeling and forecasting of labels quantities. Labels from before the requirement change are wasted, labels from after the requirement change can be delayed, and in general, a risk of application of wrong labels to products at the manufacturing facility exists.

Illustrative embodiments further recognize that when labels are produced at the manufacturing facility, the process is tedious and often requires significant expense of time and labor. For example, if a single label with specific information is needed, a person has to prepare and load proper images and text of the information, and adjust the shape and size of the combined information to fit the available label stock. Label stock is a quantity of blank labels of a certain shape and size that can be printed with the information. Finished labels are labels with the information included on the blank label stock through printing, fusing, embossing, engraving, overlaying, or other methods. Typically, a part number is associated with finished labels. Using the part numbers for finished labels, manufacturing can associate labels with a product being manufactured just as any other component with a part number would be associated with the product. Part numbers are numbers assigned to items for managing the items in an inventory. Any item, part, component, consumable, piece of information that an inventory system tracks can have a part number.

Illustrative embodiments further recognize that the source of finished labels, whether a supplier or internal, has to maintain label stock of numerous shapes and sizes which can be wasteful. Multiple label stocks imply multiple items in label stock inventory and therefore imply a large inventory. Large inventory leads to expense and waste when label requirements change.

Therefore, a method for dynamically producing labels on a single label stock, based on customer orders, and in coordination with manufacturing processes is desirable. Such a method will reduce lead time for finished labels, reduce scrapped labels and associated costs, and eliminate dependency on manual label creation. Such a method will further provide a more systematic change control process for changing labels when label requirements change.

In some cases, multiple label stock is required by the customer, government agency, or some other necessity. The method for dynamically producing labels can be used for producing labels on a variety of label stock. In dynamically producing finished labels on multiple label stock, the method is desirable for the same reasons as identified above, except that inventory of multiple label stock has to be maintained.

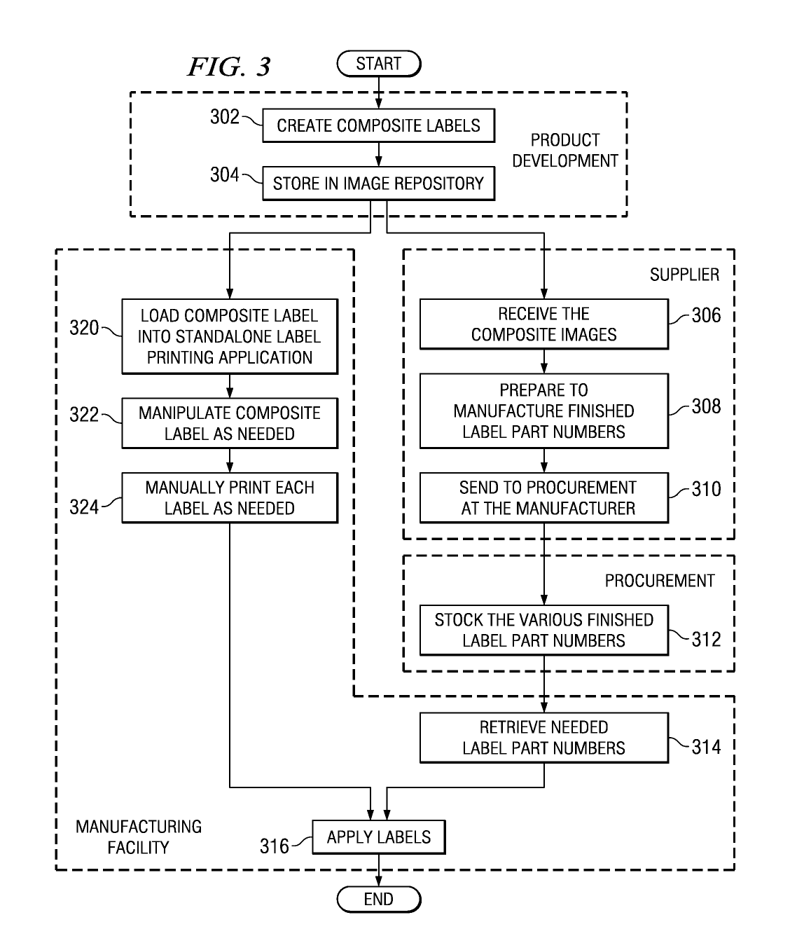

With reference now to FIG. 3, a flowchart of the labeling process that is standard in the manufacturing industry is depicted. The process can be implemented in a data processing system, such as client 114 or server 104 in FIG. 1.

Numerous composite labels for different applications are designed and released(step 302). Generally, a product development department interacts with the process for designing and releasing the composite labels. A composite label is a label image with multiple pieces of information, whether textual or in image form, arranged to fit a particular label stock. The product development department creates a variety of labels that they deem will be commonly needed when a customer order will be manufactured in the future. These composite labels are designed so that a label supplier can mass-produce the finished labels bearing the composite label image. By the very nature of this approach, such labels are not suitable for custom customer orders, or changes to an order configuration on short notice.

Next, the composite labels are stored in an image repository (step 304). An image repository is a collection of images that may be accessed. An image repository may be, for example, a database or some other data management system implemented using a data processing system, such as client 114 or server 104 in FIG. 1. The data management system may also be implemented using a storage device, such as storage 108 in FIG. 1.

The image repository is available to a label supplier's process for creating finished labels in bulk, as well as to the label creating process at the manufacturing facility. One or more label creating processes may have access to the image repository simultaneously. A supplier with access to the image repository receives one or more composite images from the image repository (step 306). Note that a supplier's access to the image repository is described here only as an example and is not intended to be limiting on the illustrative embodiments. A supplier may receive the composite images in ways other than accessing the image repository directly depending on specific implementations of the illustrative embodiments. For example, a supplier may receive a composite image via email, file transfer, and other communication methods.

The supplier prepares the label manufacturing process with tooling suitable for producing the specific finished label part number (step 308). Supplier provides the finished labels to the procurement department at the manufacturer who ordered the finished labels (step 310).

The procurement department stocks the several finished labels thus procured for access by the manufacturing facility when needed (step 312). Upon a need, the manufacturing facility retrieves the appropriate finished label part numbers for use with a product being manufactured (step 314). Manufacturing facility then uses the finished labels by applying them to the product or product packaging as needed (step 316). The process terminates thereafter.

The image repository is also accessible to a stand alone label producing capability with a label printing application at the manufacturing facility. When a finished label is needed to be produced using this stand alone capability, a composite label is loaded from the image repository into the stand alone label printing application (step 320). Typically, a manufacturing operator operates the stand alone label producing capability. The composite label is then manipulated in the label printing application to fit a particular manufacturing need (step 322). In alternative implementations of the illustrative embodiments, one of ordinary skill in the art can easily modify or combine the steps 320 and 322. For example, instead of loading a composite image in the stand alone label producing capability, the stand alone label producing capability may be able to construct the composite image from label sub-images directly in case a custom label needs to be constructed for a customer order. Additionally, the composite image or the label sub-images can be loaded automatically, systematically, or manually into the stand alone label producing capability.

The steps 320 and 322 as described are only exemplary and are not intended to be limiting on the illustrative embodiments. As the example above provides, many modifications of the steps of the process will become apparent to those of ordinary skill in the art for using the illustrative embodiments in specific implementations.

Continuing with the description of FIG. 3, the manufacturing operator then manually prints each finished label as needed (step 324). Manufacturing facility then uses the finished labels by applying them to the product or product packaging as needed (step 316). The process terminates thereafter.

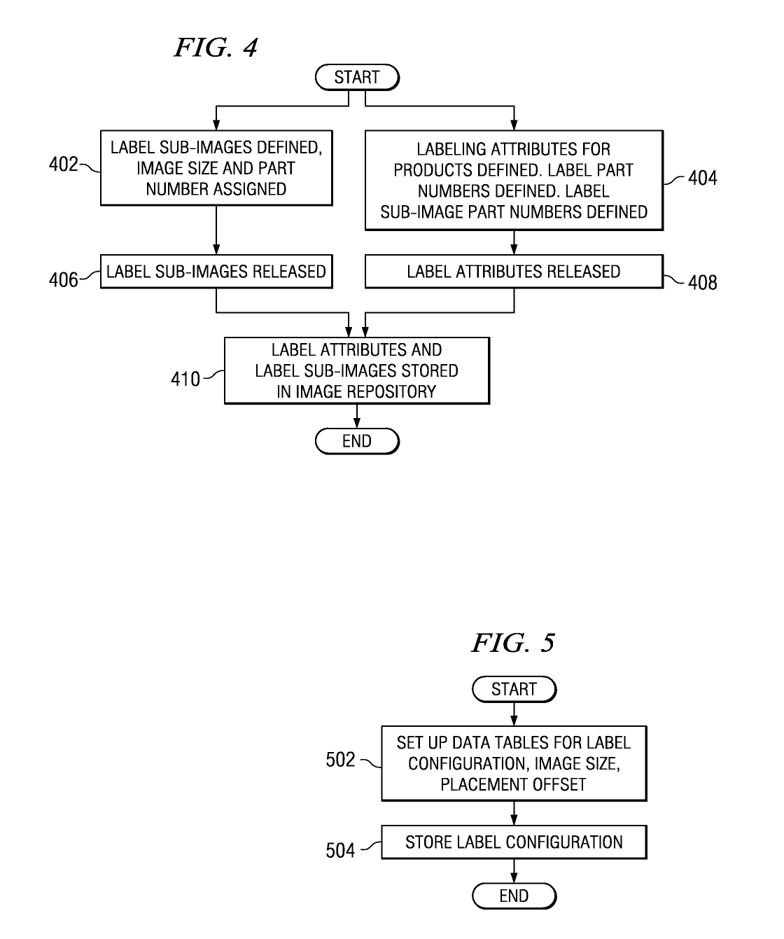

With reference now to FIG. 4, a flowchart of a process for creating the attributes of a dynamic label is depicted in accordance with an illustrative embodiment. The process can be implemented in a data processing system, such as client 114 or server 104 in FIG. 1.

Label sub-images are defined, and assigned a part number, size, and any other necessary formatting information (step 402). A label sub-image is a part of a finished label. Conversely, a finished label includes several label sub-images to convey the complete information. If the finished label is considered a single image, label sub-images are the various image building blocks that together form the single image of the finished label. Label sub-images when stored on a data processing system are just another data object. A data object is a structured representation of data describing an object.

As an example, a label sub-image may be the familiar Intel® inside™ image that is commonly seen on home computers that include a processor built by Intel®. Another familiar image that can be a label sub-image is the FCC symbol on wireless communication devices to indicate that the wireless device complies with the Federal Communication Commission's regulation governing such devices. A finished label for a computer that uses a processor built by Intel® and a wireless networking card would include the Intel® inside™ image and the FCC symbol image as sub-images along with other sub-images needed to convey the complete information about the computer.

Next, labeling attributes for products that are manufactured by the manufacturing facility are defined (step 404). Specific characteristics of a label that should be associated with a product are called labeling attributes. For example, a specific product may use a label of a specific shape, size or color, or the label on that product may need to include specific label sub-images. These specific characteristics would all be labeling attributes that will be defined for the product in step 404. A set of labeling attributes implies a group of zero or more labeling attributes.

Labeling attributes influence the formatting of the label sub-images. For example, if the labeling attribute states that the label can only be black and white, a label sub-image that is in color will need to be formatted so that a black and white version of the sub-image appears on the label. Thus, formatting information related to label sub-images include labeling attributes such as size, color, shape and any other information that is generally relevant to images.

Next, label sub-images defined in step 402 are released by product development department for use in label production (step 406). Similarly, the labeling attributes for products defined in step 404 are released by product development department for use in label production (step 408). The released label sub-images and labeling attributes are stored in an image repository (step 410). The process terminates thereafter. The image repository may be a database or some other data management system implemented using a data processing system, such as client 114 or server 104 in FIG. 1. The data management system may also be implemented using a storage device, such as storage 108 in FIG. 1.

With reference now to FIG. 5, a flowchart of a process for creating a label configuration and layout for printing is depicted in accordance with an illustrative embodiment. The process can be implemented in a data processing system, such as client 114 or server 104 in FIG. 1. A label configuration is a template for a label that defines the size and placement offset of one or more label sub-images on a label. Layout of a label stock is the shape and size of the label stock within which the finished label should fit. Placement offset is the location of a label sub-image on the label, generally provided in terms of X and Y coordinates. For example, a label sub-image with placement offset of (0,0) indicates that the label sub-image will occupy the lower left corner of the label. Size of the label sub-image indicates how big or small the label sub-image will appear on the label. Size can be specified in inches, millimeters, dots-per-inch (dpi), pixels, or any other suitable unit of measurement.

The process creates data tables for configuring various finished labels for the products to be manufactured (step 502). These data tables are based on the information released by the product development department as indicated in steps 406 and 408 in FIG. 4. Generally, personnel associated with the manufacturing facility interact with the data processing system implementing this process in order to populate the data table.

The data tables from step 502 are stored in a repository (step 504). The repository for the data tables may be a database, files in a data processing system, or some other data management system implemented using a data processing system, such as client 114 or server 104 in FIG. 1. The data management system may also be implemented using a storage, such as storage 108 in FIG. 1.

Note that singular image repository and data table repository are described in FIGS. 4 and 5 for the sake of simplicity, and are not intended to be limiting on the illustrative embodiments. Multiple repositories can be used for each of these purposes. Further, each of the multiple repositories can be located on data processing systems connected by data networks. Furthermore, repositories for different purposes may be consolidated based on implementation needs. Other configurations of repositories will become apparent to those of ordinary skill in the art from this disclosure.

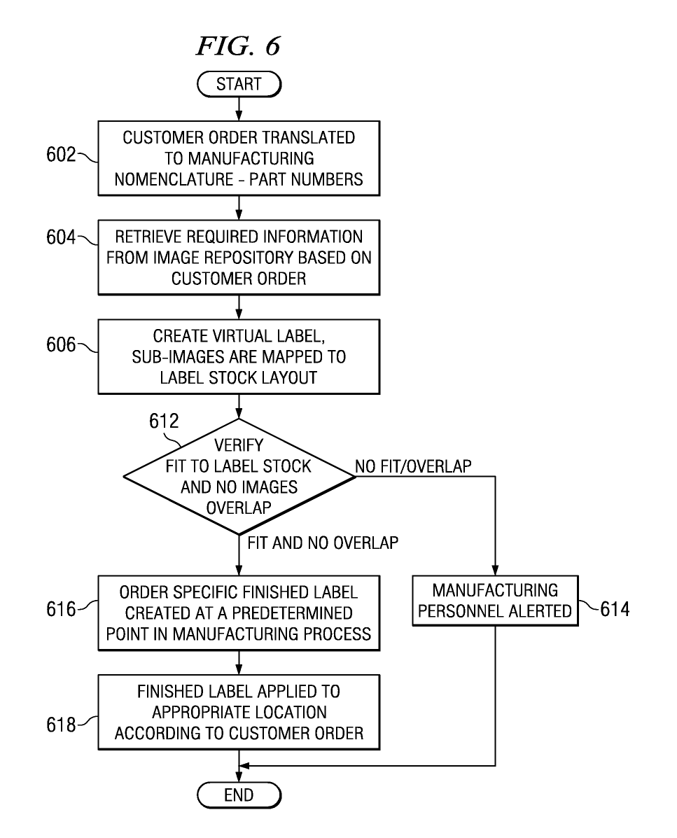

With reference now to FIG. 6, a flowchart of a process for creating a dynamic label is depicted in accordance with an illustrative embodiment. The process can be implemented in a data processing system, such as client 114 or server 104 in FIG. 1.

A customer order is translated to appropriate manufacturing nomenclature (step 602). Manufacturing nomenclature is a term, phrase, name, or identifier, which is used by the manufacturing facility for manufacturing the product in the customer order. For example, a customer places a customer order for a computer with specific capabilities, including a random access memory (RAM) of a certain size. When the customer order reaches the manufacturing facility, the random access memory of the specified size must be translated to a part number that is associated with a memory device that functions as a random access memory in a computer, is compatible with the rest of the configuration, and is of the specified size. The part number is the manufacturing nomenclature corresponding to a portion of the customer order in this example. Manufacturing facility will use the part number to retrieve the memory device from the inventory in order to manufacture the computer according to the customer order.

Based on the translated information from step 602, manufacturing facility retrieves the required information from the image repository according to the specifications of the customer order (step 604). The image repository is the repository such as the one used for storing label sub-images and labeling attributes for products in step 410 in FIG. 4. The retrieved information includes label sub-images corresponding to the part numbers translated from the customer order, and labeling attributes for the product in the customer order.

Next, a single layout of a finished label is created by mapping the label sub-images to a layout of a label stock (step 606). The single layout is the layout or design of the finished label in the form of a single image. The single layout is created in the form of a virtual layout. A virtual layout of a finished label is a computer rendering of how the actual finished label will look when created. In performing step 606, the data tables, such as those stored in a repository in step 504 in FIG. 5, are used.

The virtual layout of the finished label is verified to determine whether the finished label will fit on the label stock without having any label sub-images overlapping (step 612). If the process determines that the finished label will not fit on the label stock, or if the sub-images will overlap (“no fit/overlap” path of step 612), an alert is sent to manufacturing personnel (step 614). The process terminates thereafter.

If, however, the virtual layout of the finished label fits on the label stock without the sub-images overlapping (“fit and no overlap” path of step 612), a finished label specific to the customer order is created on the label stock by printing or other creating techniques (step 616). Creation of the finished label takes place at a predetermined point in the manufacturing process. For example, in some cases the finished label may be created after the product has been packaged, or in other cases after the product is fully assembled. Those of ordinary skill in the art will recognize that the point at which the finished label is created in the manufacturing process is variable depending on the specific implementation of the illustrative embodiments.

The finished label is then associated with the customer order, for example, by applying the finished label to the product or product packaging at the appropriate location (step 618). The process terminates thereafter.

Illustrative embodiments provide several advantages over the presently used methods of either procuring finished labels, or manually printing finished labels at the manufacturing facility. By using the illustrative embodiments, lead time associated with procurement of finished labels is eliminated. As engineering changes are processed, or as label requirements otherwise change, new label images are automatically passed to manufacturing for including on labels in coordination with manufacturing processes.

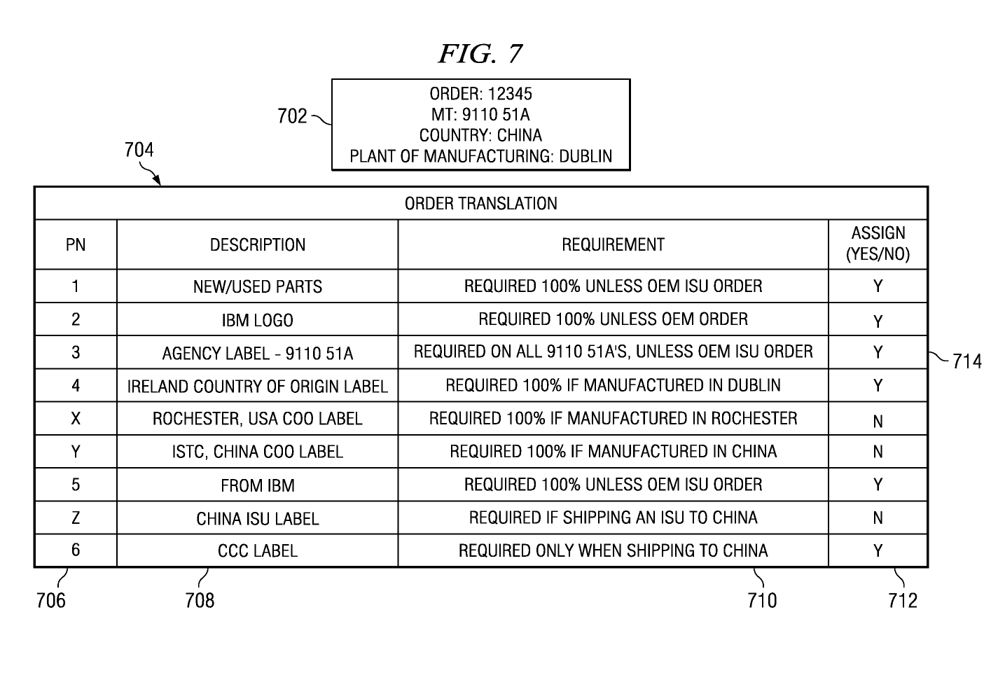

With reference now to FIG. 7, a table of items translated from a customer order to manufacturing nomenclature is depicted in accordance with an illustrative embodiment. A portion of a customer order 702 is shown to indicate that the customer order is going to be shipped to China, and that the product is to be manufactured in the manufacturing facility located in Dublin, Ireland.

Table 704 shows the labeling attributes that are translated from the portion of customer order 702. Column labeled “PN” 706 identifies part numbers for various labels that are needed according to the customer order. Column labeled “Description” 708 identifies the description of the part identified by the part number in any given row of the table. Column labeled “Requirement” 710 identifies a labeling requirement. A labeling requirement is a requirement or a condition that determines whether the part identified by the part number in any given row of the table is needed on a label. The requirement identified in column 710 must be satisfied for the part number in column 706 to be assigned in column 712. For example, a condition may be that a part number in column 706 can be assigned only if the product is being shipped to country X. A set of labeling requirements is a group of zero or more labeling requirements.

Column labeled “Assign” 712 indicates if the part identified by the part number in any given row of the table is required to be present on the finished label according to the customer order. The indicator in column 712 is a result of the determination made using the labeling requirement as described above.

As an example, row 714 identifies a part number 3, which is an agency label 9110 51A, which is a compliance certificate. Column 710 entry in row 714 indicates that a label sub-image corresponding to this compliance certificate is required on all customer orders of the type specified, unless the order is for an incomplete system unit (ISU). Because portion of the customer order 702 indicates that the customer order is of this type, column 712 entry in row 714 indicates that the label sub-image for the compliance certificate will be assigned to the finished label.

With table 704 interpreted according to the example provided above, the finished label for the customer order shown in 702 will contain label sub-images for part numbers 1, 2, 3, 4, 5, and 6. The finished label will not contain label sub-images for part numbers X, Y, and Z.

This example shows the customization of the labeling that is necessary depending on the customer order when manufacturing certain products. The translation table in FIG. 7 and the interpretation thereof are only described as examples. They are not intended to be limiting on the illustrative embodiments. Many other translations and methods of interpretations for various implementations will become apparent to those of ordinary skill in the art from this disclosure.

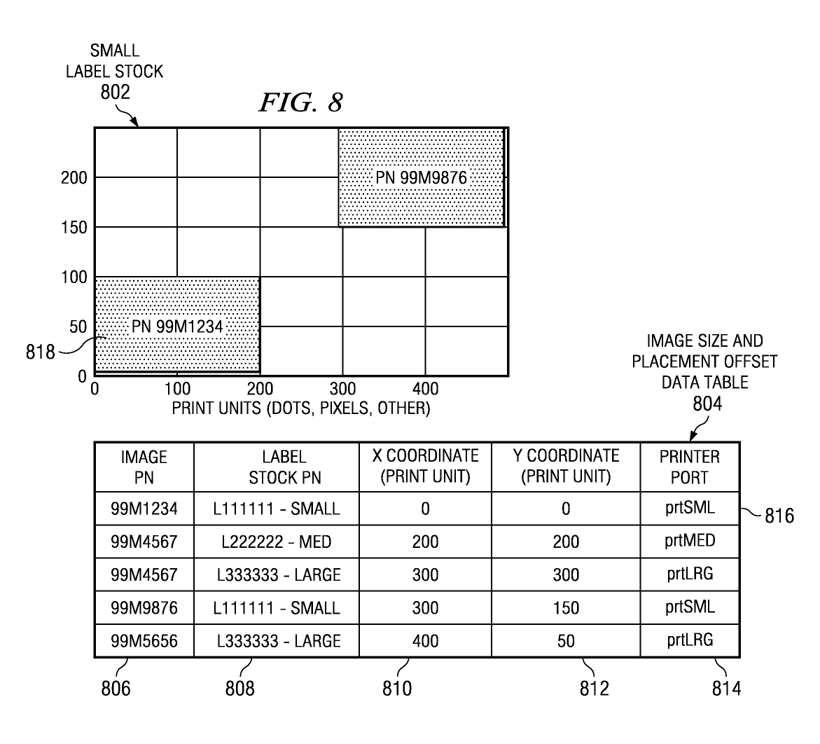

With reference now to FIG. 8, a sample label data table is shown in accordance with an illustrative embodiment. Exemplary small label stock 802 is shown, which is used for creating a finished label. The finished label is created by placing label sub-images according to data table 804. Data table 804 is similar to the data table stored for label configuration in step 504 in FIG. 5.

Column 806 indicates a part number for the label sub-image to be placed on the label stock. Column 808 indicates the label stock for which the sub-image is suitable. Note that a sub-image part number may be suitable for more than one label stock.

Next, columns 810 and 812 together indicate the placement of the sub-image on the label stock in terms of X and Y axes coordinates. X and Y coordinates are used for indicting position of an object on a two dimensional surface. Note that exemplary data table 804 shows only two dimensions for clarity. Implementation specific data tables could also show a Z coordinate for the height of the sub-image that could be useful in giving the sub-image a three dimensional effect. For example, a sub-image could be Braille script for some information that needs to be embossed to a certain height on the label for readability by visually impaired persons.

A label may not be printed or otherwise created in one step. A complex label can be envisioned to require a several-step printing process, such as used in color screen-printing, to appear as desired. Column 814 indicates which printer, creating device, or crating step the sub-image is sent to for rendition on the finished label. Here, rendition, or rendering is the process of actual reproduction of an image on a target surface.

As an example, row 816 shows that a label sub-image with part number 99M1234 can be printed on small label stock at position (0,0), through printer called prtSML. Block 818 on small label stock 802 is an exemplary rendition of the label sub-image configuration identified in row 816.

This example shows the creation of a finished label that is customized according to a customer order. The data table in FIG. 8 and the interpretation thereof are only described as examples. They are not intended to be limiting on the illustrative embodiments. Many other table entries for various implementations will become apparent to those of ordinary skill in the art from this disclosure.

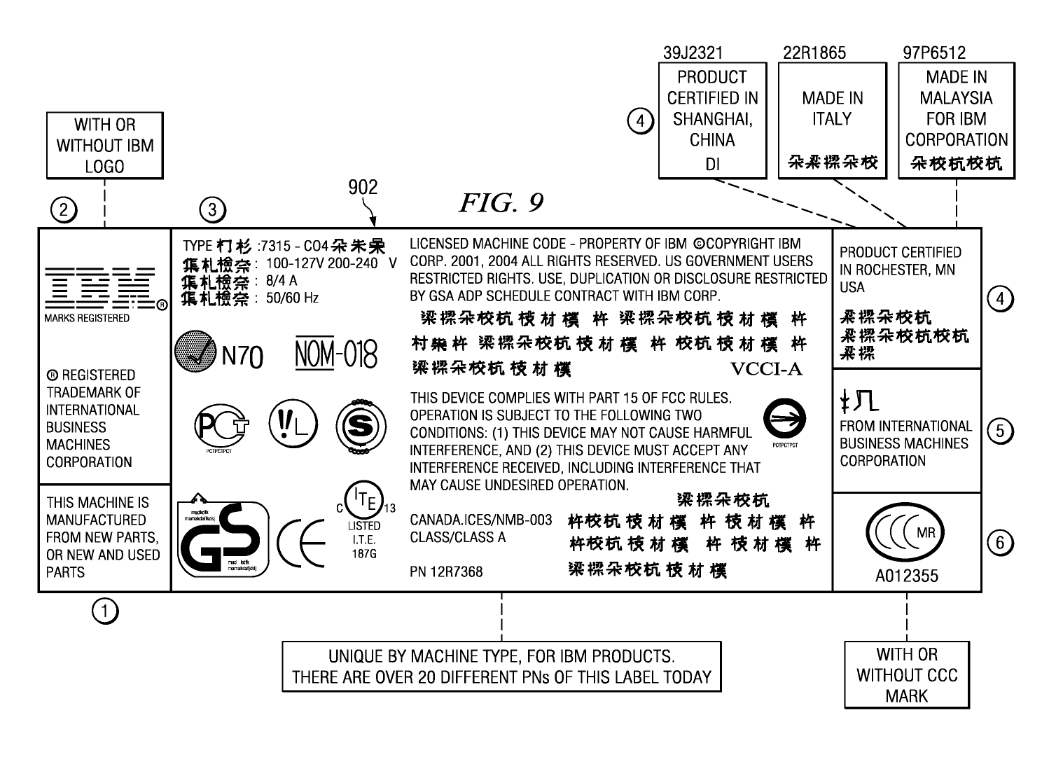

With reference to FIG. 9, a diagram of a finished label is depicted in accordance with an illustrative embodiment. Finished label 902 shows the placement and rendering of the part numbers 1, 2, 3, 4, 5, and 6 shown in table 704 in FIG. 7, and described in the corresponding description above.

The illustrative embodiments also eliminate the need to procure, manage, and apply numerous different label part numbers by providing a single label which is customized for the customer order and specific label requirements. In this manner, the need for supplier forecast and planning at individual label part numbers is also eliminated.

Manufacturing facilities only plan for a generic label stock to accommodate their labeling needs. Manual printing of custom labels is also eliminated because the illustrative embodiments can generate one or more labels dynamically. Illustrative embodiments further provide a better change control process for change in label requirements, particularly for the changes made on short notice.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for dynamically creating a label, the computer implemented method comprising:
selecting a plurality of images from a repository of images, based on a customer order to form selected images;
identifying a plurality of label configurations for the selected images in a second repository of label configurations; and
arranging the selected images according to the plurality of label configurations into a single layout to form a finished label, wherein the finished label is included with a product according to the customer order.

2. The computer implemented method of claim 1, wherein the selected images comprise:
at least one label sub-image; and
formatting information related to the at least one label sub-image, wherein formatting information comprises:
a label sub-image size; and
a set of labeling attributes.

3. The computer implemented method of claim 2, wherein the at least one label sub-image is a data object capable of rendering in at least one of two and three dimensions.

4. The computer implemented method of claim 2, wherein the set of labeling attributes comprises:
a label sub-image part number;
a part number according to the customer order; and
a set of labeling requirements determining whether the label sub-image part number should be assigned to the customer order.

5. The computer implemented method of claim 1, wherein as a part of being included with the product according to the customer order, the finished label is printed on a blank label stock, and wherein the finished label is affixed to one of the product and a packaging of the product.

6. The computer implemented method of claim 1, wherein a label configuration in the second repository comprises:
at least one placement offset of a label sub-image in the finished label; and
at least one size of the label sub-image in the finished label.

7. The computer implemented method of claim 1, wherein the repository of images and the second repository of label configurations are one of a common repository, and separate repositories.

8. A computer usable program product comprising a computer usable medium including computer usable code for dynamically creating a label, the computer usable code comprising:
computer usable code for selecting a plurality of images from a repository of images, based on a customer order to form selected images;
computer usable code for identifying a plurality of label configurations for the selected images in a second repository of label configurations; and
computer usable code for arranging the selected images according to the plurality of label configurations into a single layout to form a finished label, wherein the finished label is included with a product according to the customer order.

9. The computer usable program product of claim 8, wherein the selected images comprise:
at least one label sub-image; and
formatting information related to the at least one label sub-image, wherein formatting information comprises:
a label sub-image size; and
a set of labeling attributes.

10. The computer usable program product of claim 9, wherein the at least one label sub-image is a data object capable of rendering in at least one of two and three dimensions.

11. The computer usable program product of claim 9, wherein the set of labeling attributes comprises:
a label sub-image part number;
a part number according to the customer order; and
a set of labeling requirements determining whether the label sub-image part number should be assigned to the customer order.

12. The computer usable program product of claim 8, wherein as a part of being included with the product according to the customer order, the finished label is printed on a blank label stock, and wherein the finished label is affixed to one of the product and a packaging of the product.

13. The computer usable program product of claim 8, wherein a label configuration in the second repository comprises:
at least one placement offset of a label sub-image in the finished label; and
at least one size of the label sub-image in the finished label.

14. The computer usable program product of claim 8, wherein the repository of images and the second repository of label configurations are one of a common repository, and separate repositories.

15. A system for dynamically creating a label, the system comprising:
a repository of images for selecting a plurality of images from the repository based on a customer order to form selected images;
a second repository of label configurations for identifying a plurality of label configurations for the selected images in the second repository; and
a component for arranging the selected images according to the plurality of label configurations into a single layout to form a finished label, wherein the finished label is included with a product according to the customer order.

16. The system of claim 15, wherein the selected images comprise:
at least one label sub-image; and
formatting information related to the at least one label sub-image, wherein formatting information comprises:
a label sub-image size; and
a set of labeling attributes.

17. The system of claim 16, wherein the at least one label sub-image is a data object capable of rendering in at least one of two and three dimensions.

18. The system of claim 16, wherein the set of labeling attributes comprises:
a label sub-image part number;
a part number according to the customer order; and
a set of labeling requirements determining whether the label sub-image part number should be assigned to the customer order.

19. The system of claim 15, wherein as a part of being included with the product according to the customer order, the finished label is printed on a blank label stock, and wherein the finished label is affixed to one of the product and a packaging of the product.

20. The system of claim 15, wherein a label configuration in the second repository comprises:
at least one placement offset of a label sub-image in the finished label; and
at least one size of the label sub-image in the finished label.
